(19) United States
(12) Patent Application Publication
(10) Pub. No.: US 2008/0124610 A1
(43) Pub. Date: May 29, 2008

(54) BIOPOLAR PLATE, IN PARTICULAR FOR A FUEL CELL

(75) Inventors: Wolfram Kaiser, Stuttgart (DE); Markus Watzlawski, Ostfildern (DE); Jan Martin Kreye, Eckernforde (DE)

Correspondence Address: FOLEY AND LARDNER LLP;SUITE 500, 3000 K STREET NW, WASHINGTON, DC, 20007, US

(73) Assignee: BEHR GMBH & CO. KG

(21) Appl. No.: 11/942,485

(22) Filed: Nov. 19, 2007

(30) Foreign Application Priority Data
Nov. 20, 2006 (DE) 10 2006 054 849.3

(51) Int. Cl. H01M 8/02

(52) U.S. Cl. 429/35; 429/34

(57) ABSTRACT

The invention relates to a bipolar plate (1) for a fuel cell stack, comprising two disc parts (2.1, 2.2) which are joined to one another on the inside in a functionally tolerant manner with respect to the capability for fluid and/or gas to pass through, forming internal cavities.

The invention relates to a bipolar plate, in particular for a fuel cell, in particular a PEM fuel cell (PEM=polymerelectrolyte), a direct-methanol fuel cell or some other suitable fuel cell.

The use of fuel cells to convert chemical energy to electrical energy represents an efficient and environmentally friendly method for obtaining electrical power from the elements hydrogen and oxygen. In this case, two physically separate electrode reactions normally take place, in which electrons are released and/or bonded. The reactants oxygen and hydrogen may be provided in the form of various fluids, and they need not necessarily be in a pure form. The use of pure, molecular oxygen and hydrogen is, for example, just as possible as the use of oxygen from the air and methane. A first example of two corresponding electrode reactions in a polymer electrolyte fuel cell (PEMFC or PEM fuel cell for short) comprises the following reactions:

H₂=>2H⁺+2e⁻ (anodic reaction)

2H⁺+2e⁻+½O₂=>H₂O (cathodic reaction)

The type of reaction depends on the type of fuel cell and on the fluids used. In the case of a solid oxide fuel cell (SOFC for short), by way of example, the following reactions can be observed:

H₂+O₂⁻=>H₂O+2e⁻ (anodic reaction I)

CO+O₂⁻=>CO₂+2e⁻ (anodic reaction II)

O₂+4e⁻=>2O₂⁻ (cathodic reaction)

Some other fuel cell types have different reactions. One common feature of all fuel cells is on the one hand the transport of an ion type through an electrolyte and on the other hand the transport, in parallel, of electrons through an outer conductor, in order to return the ions to an electrically neutral state after the transport process.

As a result of an electrical connection of the physically separate reaction zones, some of the reaction enthalpy that is released in this case can be obtained directly as electrical power. Normally, a plurality of fuel cells which are connected electrically in series are stacked one on top of the other, and a stack that has been formed in this way is used as a power source.

An single fuel cell in this case comprises an electrolyte unit such as a membrane and two electrodes covered with catalyst material. The membrane is located between the reactants, isolating them, with the reactants being, in particular, hydrogen and oxygen in the case of the PEM fuel cell or hydrogen/carbon-monoxide and oxygen in the case of a solid-oxide fuel cell, or a methanol/water mixture and oxygen in the case of a direct-methanol fuel cell, and has an ion conductivity, for example an H⁺-proton conductivity in the case of a DMFC or PEM fuel cell, or O₂ conductivity in the case of a solid-oxide fuel cell.

The electrodes are required, inter alia, in order to tap off the electrical power produced by the fuel cell.

The fluids (also referred to as reactants, reaction media or working fluids), for example hydrogen and oxygen, and the reaction product of water flow through fluid channels into the areas of the reaction zones, and out of them. A channel system of fluid channels for a specific fluid is in general also referred to as a flow field.

In order to achieve optimum efficiency, the geometry of the flow fields for the respective reaction media is matched to the respective type of flow medium (for example transport of hydrogen/reformate (gaseous) and transport of methanol/water (liquid/gaseous) and of oxygen (air) and the resultant product water).

Various concepts of fuel cell stacks (individual fuel cells stacked one on top of the other) are known, in which the waste heat is transported away via one of the two reaction media, so that there is no need for any specific cooling flow field for each individual cell. Particularly in the case of direct-methanol fuel cells, the temperature of the individual fuel cells can easily be managed by the liquid fuel fluid (methanol/water mixture).

In addition to achieving particularly high efficiency, the provision of a bipolar plate which can be produced at the minimum possible cost is nowadways a priority development aim. The invention is therefore based on the object of specifying a bipolar plate which is better than the prior art, requires as little production effort as possible to manufacture, and is particularly highly efficient. A further aim is to specify a better fuel cell stack.

With regard to the bipolar plate, the object is achieved according to the invention by the features of claim 1. With regard to the fuel cell stack, the object is achieved according to the invention by the features of independent claims 21 and 22.

Advantageous developments of the invention are the subject matter of the dependent claims.

According to one fundamental idea of the invention, a bipolar plate for a fuel cell stack comprises two disc parts which are electrically conductively connected to one another and of which a first disc part only partially covers a second disc part in the stacking direction of the fuel cell stack. There is therefore no longer any need for a seal between the first and the second disc part in some circumstances, so that the bipolar plate does not itself any longer need to be leak-tested, as is the case with known bipolar plates which have two completely covering disc parts.

The second disc part is advantageously provided with one or more inlets and/or outlets, which are in the form of apertures, for a first reaction medium, and with an area of the second disc part which is not covered by the first disc part comprising a part of the circumferential rim, in particular the entire circumferential rim of at least one or all of the apertures. By way of example, sealing by means of a sealing element between the second disc part and an adjacent component of the fuel cell stack, for example an electrolyte unit then contributes in a preferred manner to there no longer necessarily being any need for sealing between the first and the second disc part for functional reliability of the bipolar plate.

A bipolar plate for a fuel cell stack is preferably composed of two disc parts which are joined to one another on the inside such that, if required, fluid and/or gas can pass through, at least in places, with internal cavities being formed, and which are functionally tolerant if the joint is incomplete in places. In this case, functional tolerance refers to a state in which the associated fuel cell can be operated functionally and reliably irrespective of the characteristic of the joint in places. In particular, a fluid is a liquid or some other flowing medium, allowing a fluid to pass through means that a liquid can pass through. For this purpose, the two disc parts are of different size. In this case, the disc parts each have at least one channel structure which, at least in places, forms at least one associated flow field. The flow field of the respective disc part is in the form of an outer flow field on the outside, facing away from the other disc part, with a medium, in particular reaction medium, for example air, water, hydrogen, methanol, air, mixtures of them and possibly with reaction products, flowing through the relevant channel structure. The first reaction medium mentioned above is then preferably associated with the channel structure or the flow field of the second disc part.

During the production of the bipolar plate by joining the two disc parts together, for example by welding, soldering, pressing, this avoids the need for complex leak testing of the joint bead, which would otherwise be necessary. If a reaction medium enters the internal cavities which may result from the joining process between the two disc parts, this is irrelevant to the operation and operational reliability of the fuel cell. This is achieved in that the area of the bipolar plate to be sealed is fitted on the outside and with respect to the reaction media on a first, larger-area disc part which for this purpose is provided, for example, with an elastomer seal which surrounds the second, smaller-area disc part. In particular, a disc part means a flat component with or without recesses, a component with surface structures and/or recesses, or any formed component with predetermined dimensions.

In one advantageous embodiment, the two disc parts have different external dimensions. In other words: the bipolar plate essentially comprises two disc parts, for example half shells, of different size which are joined together and connected to one another by a suitable joining process, for example welding, soldering or adhesive bonding. The external dimensions of one of the disc parts expediently correspond at least to the external dimensions of the associated flow field, and thus to the area of the active cell surface. The external dimensions of the other, and in particular larger, disc part correspond at least to the external dimensions of the associated flow field and of a frame surrounding this flow field, together with inlet and outlet apertures (“ports”) for the reaction media and the required sealing areas. Reducing the size of one of the disc parts of the bipolar plates saves both material and manufacturing costs. Furthermore, particularly for small-format bipolar plates and fuel cell stacks, this considerably reduces the effort required for quality assurance and leak testing, and therefore the test time.

The larger disc part is expediently provided in the area of the frame with inlets for supplying reaction media, in particular hydrogen and air, and corresponding outlets for carrying away reaction products, and residues of reaction products, in particular water and carbon dioxide. In order to transfer the reaction media into and out of the associated flow field, transfer elements are preferably provided in the area of the inlets and outlets. The transfer elements (also referred to as bridging elements) are in this case used for the reaction media to pass through and to support the inlets and outlets, which open into the channel structure of the respective flow field. In other words: the transfer elements mean that a sealing element which surrounds the inlet and outlet, for example an elastomer seal, does not interrupt the inlet and outlet processes.

The transfer elements may be designed in various ways. In one possible embodiment, the transfer element is in the form of a separate insert element (also referred to as an inlay) which extends in the longitudinal direction between an inlet or an outlet and one or more of the flow channels and is arranged transversely with respect to them. In the simplest case, a transfer element such as this is composed of a bending-resistant piece of sheet metal which has corresponding structures, in particular recesses and/or beads. Alternatively, the transfer elements may be arranged on one of the two or on both of the disc parts, in particular by being sprayed onto them. In a further alternative embodiment, the transfer elements may be integrated in a sealing element.

In a further preferred embodiment, the flow fields are each surrounded by a sealing element. In this case, the sealing elements seal the flow fields from one another and from the outside. For this purpose, the sealing element preferably completely surrounds the respective flow field of the disc part and the inlets and outlets. Joints are therefore safely avoided in the inlet and outlet area of the disc parts. In consequence, there is no need to carry out leak testing in the inlet and outlet area of the bipolar plate. All that is needed is leak testing of the individual disc parts, in particular of the metal sheets, at open points, for example holes, by visual examination.

A sealing element is preferably arranged on each of the two sides, in the area of the frame of the larger disc part. In this case, the sealing element which is arranged in the direction of the smaller disc part completely surrounds the small disc part. In other words: the smaller disc part is located in the sealing element. The outer flow fields are therefore sufficiently well sealed from one another. Furthermore, this saves material and costs.

The two disc parts can advantageously be positioned with respect to one another in advance of the joining process by means of structures which engage in one another, for example studs and beads.

The sealing element is expediently in the form of a further disc part composed of a deformable material. For example, the sealing element is a molding, in particular an elastomer seal. When the bipolar plate is being joined to adjacent components, for example the membrane electrode assembly, the elastomer seal rests in an interlocking manner on the webs, which project out of the disc parts, of the respective flow field and on the outer contours of the inlets and outlets, thus sealing the outer flow fields from one another and from the outside, such that media cannot pass through.

Depending on the requirement, the sealing element may be arranged on, in particular sprayed on, one of the disc parts, in particular on the larger disc part. Alternatively, the sealing element may be arranged on, in particular sprayed on, a membrane electrode assembly which is adjacent to the disc parts on the outside. One of the sealing elements may also be arranged on the disc part, and the other on the membrane electrode assembly.

Each sealing element is expediently formed with a locally different height. In consequence, the sealing element is matched as well as possible to the surface contour of the respective disc part. Furthermore, the frame can be provided with a recess for holding the sealing element. This allows the sealing element to be fixed and held easily before and during the joining of the fuel cell stack.

In a further embodiment, one of the disc parts may be provided with openings, in particular tapping holes, slots, rectangles, squares, and with the internal cavity between the two disc parts being filled with a relevant reaction medium. In this case, in particular, the smaller disc part is provided with openings. In the event of a disturbance in the supply of reaction medium, the reaction medium that is buffered there can maintain the fuel cell reaction, at least to an extent restricted to the size of the buffer and the diffusion capability of the reactant.

The disc parts are formed metal parts, in order to form different flow fields and different numbers of them. The forming of the disc parts results in an associated flow field for reaction media on the respective outside, and the respective negatives of the outer flow fields form the internal cavities. In one particular embodiment, the disc parts are, in particular, formed identically, that is to say they are provided with mutually corresponding channel structures such that, when the stack is pressed together, no damage occurs to the membrane electrode assembly, for example by shearing off as a result of channel-web geometries of adjacent or mutually engaging bipolar plates being pressed onto one another. In this case, the respective channel structure is formed for example by introducing beads with a width of 0.5 mm to 3 mm and with a depth of 0.1 mm to 2 mm into the disc parts. The beads may have a meandering profile. The flow field is formed by these beads and by webs which are located between two beads and connect the respective inlet and outlet on different paths. Any other structural forming can also be provided, in order to form a flow channel. The bead shape is particularly simple and cost-effective to manufacture in the case of a disc part in the form of a metal sheet.

For reaction effectiveness that is as sufficiently good as possible, the inlets and outlets provided for the flow fields are arranged at the edges and opposite one another, in particular diagonally opposite one another, and in particular are incorporated in the large disc part.

The advantages achieved by the invention are, in particular, that the disc parts of a bipolar plate which are joined in a functionally tolerant manner on the inside with regard to the capability for fluid and/or gas to pass through mean that there is no need for extensive leak testing of the joint bead. For sealing which is sufficiently good towards the outside and separates the two reaction media from one another, the external dimensions of one of the two disc parts are smaller than the other disc part, and it is embedded in a completely surrounding sealing element. Furthermore, material is saved by the disc parts being of different size. In addition, this makes it possible to provide a bipolar plate which is particularly compact and can be produced variably for a bipolar fuel cell stack and which, in turn, can be produced at particularly low cost because of the considerably reduced number of leak tests.

According to a further fundamental idea of the invention, a bipolar fuel cell stack comprises at least one bipolar plate, a sealing element and at least one electrolyte unit, in particular a membrane electrode assembly, with the bipolar plate comprising two disc parts which are electrically conductively connected to one another, a first disc part of which at least partially covers a second disc part in the stacking direction of the fuel cell stack, and is arranged in an intermediate space between the electrolyte unit and the second disc part, with the second disc part being provided with one or more inlets and/or outlets, which are in the form of apertures, for a first reaction medium, and with the sealing element sealing at least one or all of the apertures from the intermediate space with the first disc part. Once again, this means that there is no longer any need for sealing between the first and the second disc part in some circumstances, so that the bipolar plates no longer need to be leak-tested in their own right before being stacked to form the fuel cell stack.

It is particularly preferable for the sealing element to touch a part of the circumferential rim, in particular the entire circumferential rim of at least one or all of the apertures. This likewise contributes to it no longer being absolutely essential to carry out leak testing on the bipolar plate itself.

Exemplary embodiments of the invention will be explained in more detail with reference to a drawing, in which:

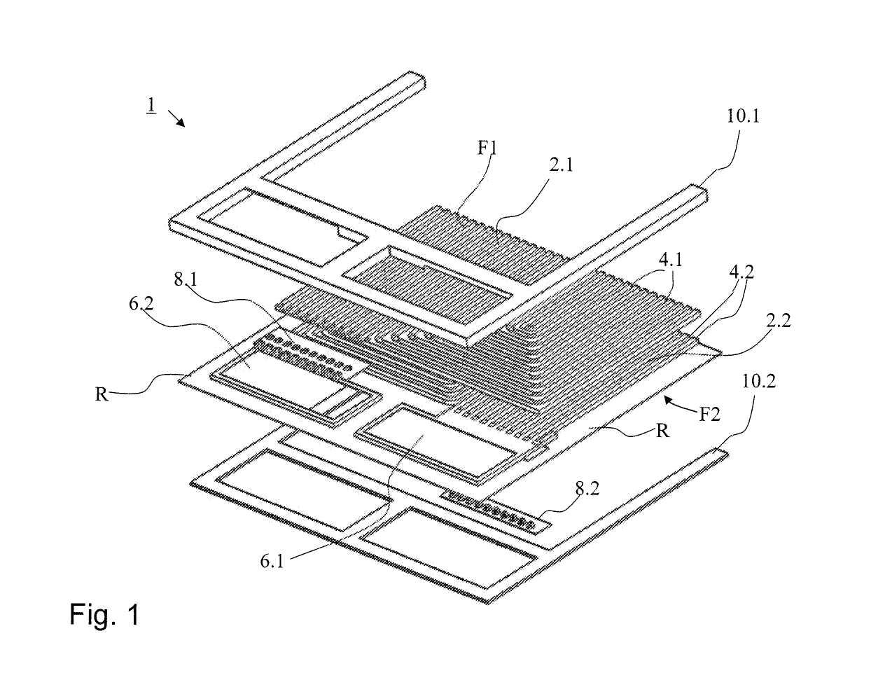

FIG. 1 shows, schematically and in the form of an exploded illustration, a detail of a bipolar plate, which is symmetrical about a point and has two disc parts of different size, and two sealing elements provided on the outside,

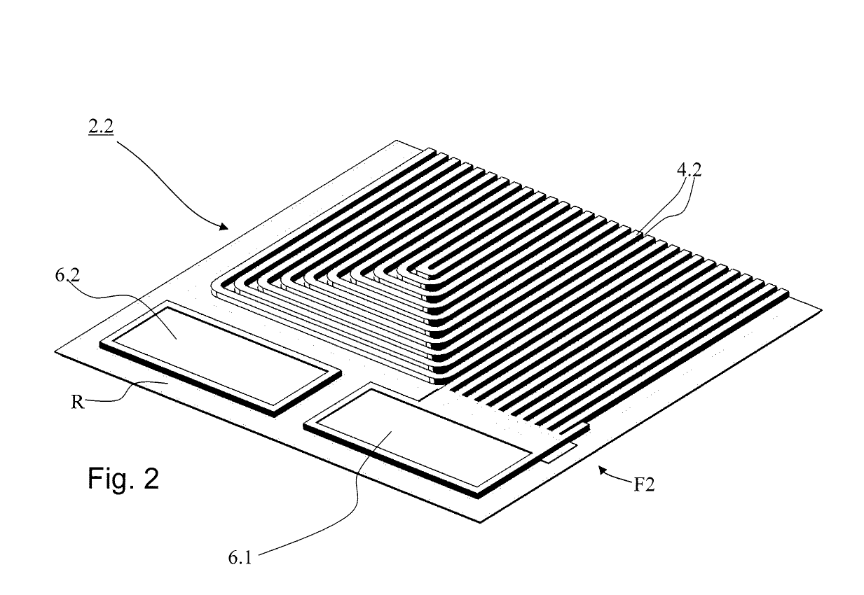

FIG. 2 shows, schematically, the larger of the two disc parts shown in FIG. 1,

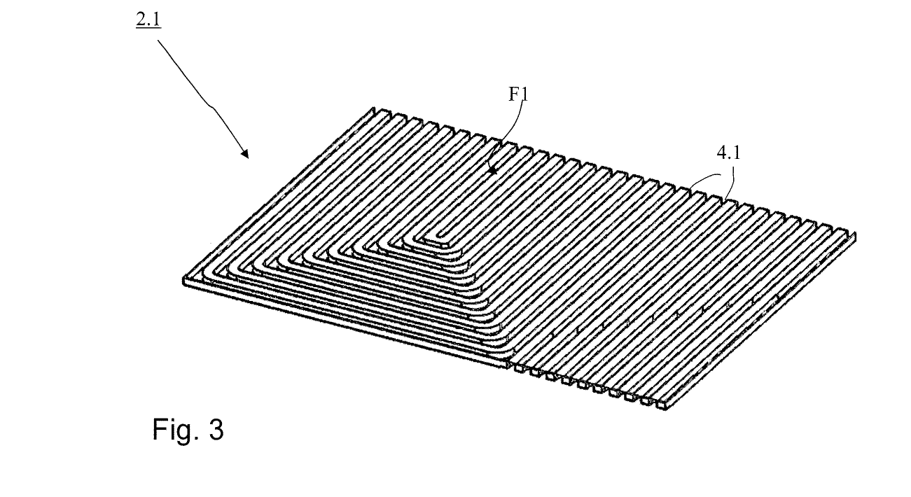

FIG. 3 shows, schematically, the smaller of the two disc parts shown in FIG. 1,

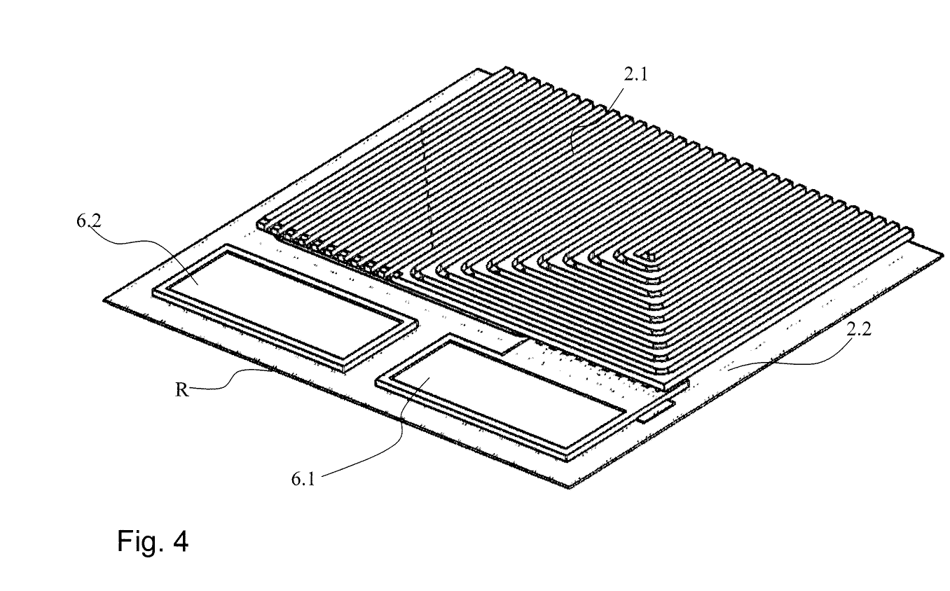

FIG. 4 shows, schematically, the two disc parts of the bipolar plate as shown in FIG. 1, in the joined state,

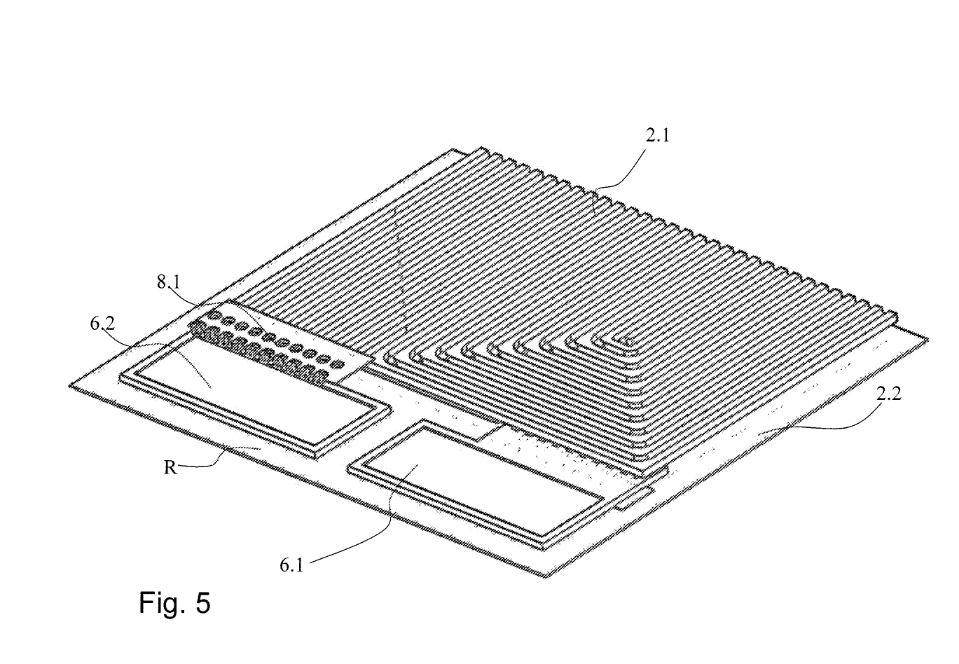

FIG. 5 shows, schematically, a transfer element in the inlet area of one of the two disc parts shown in FIG. 1,

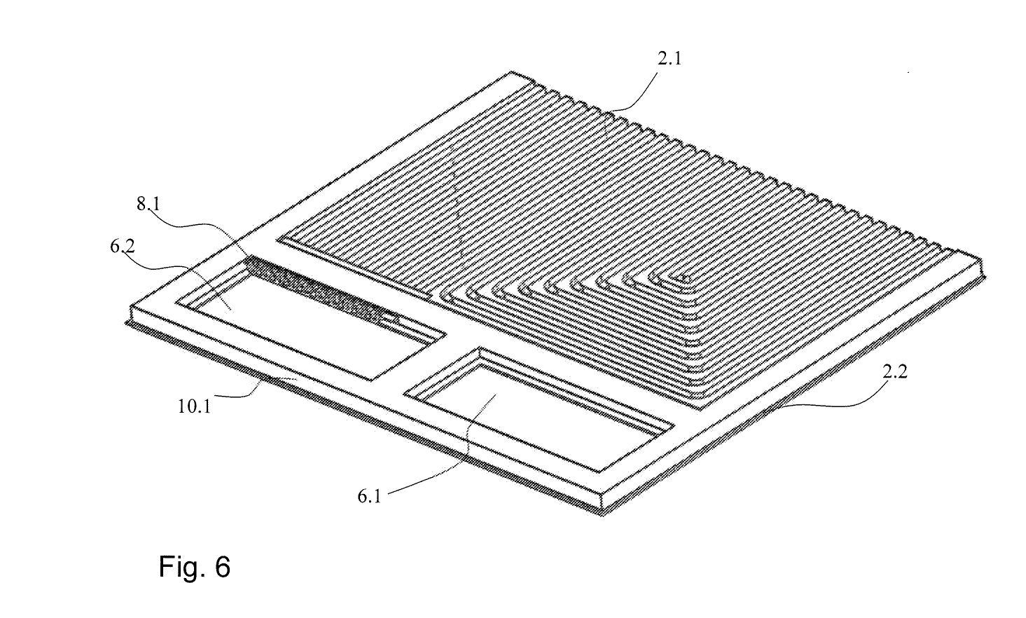

FIG. 6 shows, schematically, a sealing element which surrounds the small disc part and makes contact in the rim area of the large disc part,

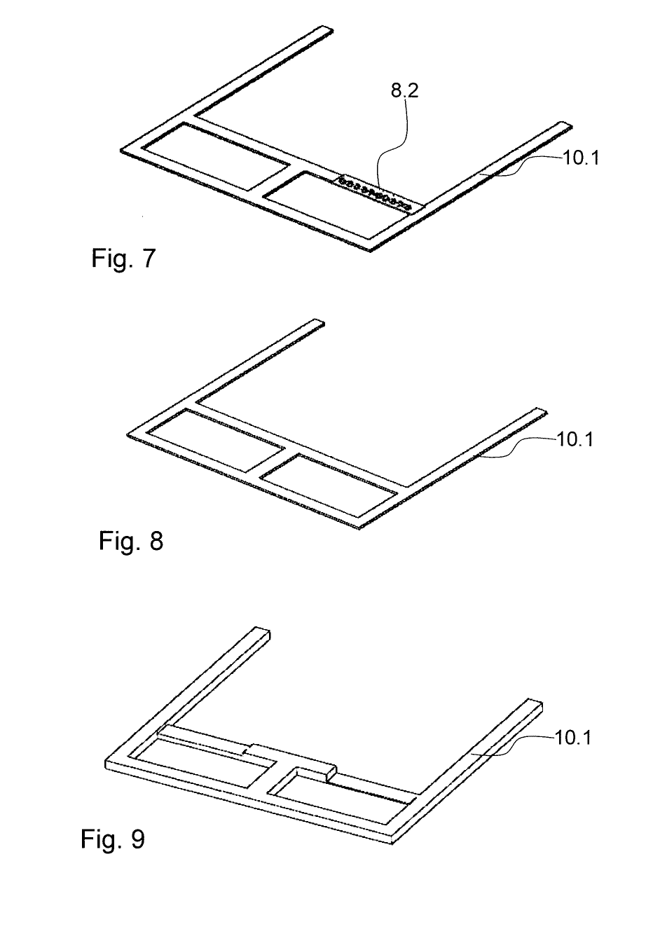

FIGS. 7 to 9 show, schematically, various embodiments of a sealing element,

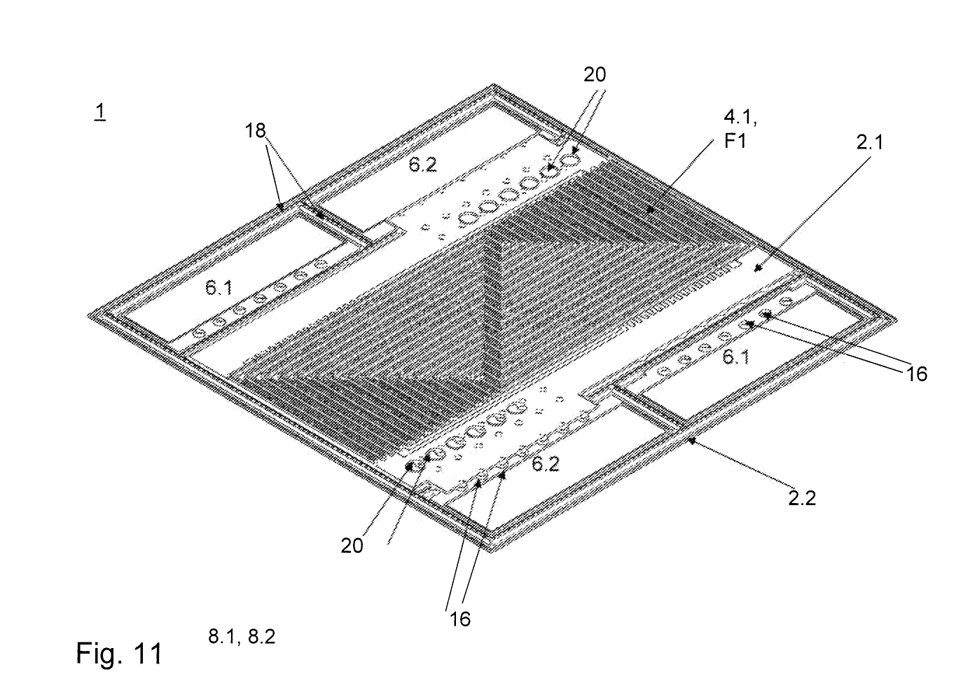

FIGS. 10 to 16 show, schematically, a further embodiment of a bipolar plate having a sealing web, which is used as a base, for the outer sealing elements, and

FIG. 17 shows, schematically, a bipolar fuel cell stack formed from a plurality of individual fuel cells.

Mutually corresponding parts are provided with the same reference symbols in all the figures.

FIG. 1 shows, schematically, an exploded illustration of a bipolar plate 1 for a fuel cell stack as illustrated in FIG. 17. In this case, FIG. 1 shows one half of a bipolar plate 1 which is symmetrical about a point. In this case, symmetrical about a point means that one half of the bipolar plate 1 is reflected about an axis running at right angles to the plane of the plate. The bipolar plate 1 is formed from two disc parts 2.1 and 2.2. The two disc parts 2.1 and 2.2 are so-called half shells, in particular half shells which correspond to one another, and form a disc pair. The two disc parts 2.1 and 2.2 are joined together at least in places to form a disc stack, for example by welding, soldering or mechanical forming. The disc parts 2.1 and 2.2 are preferably manufactured as metal sheets, in particular stainless-steel sheets. The arrangement of a plurality of such disc packs to form a disc stack with at least membrane electrode assemblies arranged between them forms a fuel cell stack. The disc packs, that is to say bipolar plates 1, are in this case stacked one on top of the other in a manner which is not illustrated in any more detail, alternately with membranes which are provided with electrodes on both sides.

In detail, the two disc parts 2.1 and 2.2 each have at least one channel structure 4.1 and 4.2 which forms at least one associated flow field F1 and F2 for reaction media, for example hydrogen and oxygen, or a methanol-water mixture and oxygen. The flow fields F1 and F2 are located on the outside, that is to say on the outside facing away from the respective other disc part 2.1 or 2.2. In this case, the flow field F1 of the first half shell or of the first disc part 2.1 has a first reaction medium flowing around it on its outside facing away from the second disc part 2.2, while the flow field F2 of the second disc part 2.2 has a second reaction medium flowing around it on the surface which faces away from the boundary surface to the first disc part 2.1, and in the area of the first disc part 2.1 (frame R) which surrounds the second disc part 2.2. The channel structures 4.1 and 4.2 are introduced into the disc parts 2.1 and 2.2, respectively, by forming, for example by introduction of beads. The beads run essentially parallel to one another in the longitudinal direction and transverse direction of the disc parts 2.1 and 2.2. The negatives of the outer flow fields F1 and F2 form the internal cavities. In one particularly preferred embodiment, the flow field F1 of the smaller disc part 2.1 has fuel flowing over it, for example a methanol-water mixture, and the flow field F2 of the larger disc part 2.2 has an oxidizer, for example oxygen from the air, flowing over it.

In order to form the bipolar plate 1, the two disc parts 2.1 and 2.2 are joined to one another at least in places in the rim area located on one another, and to the inside at least in places in a manner which allows fluid and/or gas to flow through, forming internal cavities. This means that there is no need for leak testing of the joint bead of the bipolar plate 1, as a result of the process of joining the two half-shells. Since the leak testing costs for a single bipolar plate 1 are not inconsiderable, but the bipolar plate size has only a secondary effect on the test time, this is particularly advantageous for small-format bipolar plates, for example bipolar plates with an active cell area of less than 200 cm². In a further embodiment, the disc part 2.1 is formed in the area of the transition element 8.1 so as to essentially avoid significant transport of the reaction medium flowing over the disc part 2.1 on the side facing away from the membrane electrode assembly, that is to say in the cavities between the disc parts 2.1 and 2.2. This can be achieved by the disc part 2.1 being shaped in the inlet-flow area by means of geometries which engage in one another in a similar manner to the structure in FIG. 1 et seqq. in the prior German application DE 10 2006 037 353.7 or in the form of a carton-of-eggs configuration such that no significant medium transport takes place between the disc parts 2.1 and 2.2.

Furthermore, the two disc parts 2.1 and 2.2 are of different size. In this case, the external dimensions of the disc part 2.1 are smaller than those of the disc part 2.2. This considerably reduces the amount of the stainless steel required for production. In particular, the external dimensions of the disc part 2.1 correspond to the external dimensions of the associated flow field F1. The external dimensions of the larger disc part 2.1 are formed by the external dimensions of a frame R which surrounds the associated flow field F2.

In order to supply the reaction media and to carry them away, FIG. 1 shows an inlet 6.1 for one reaction medium, and an outlet 6.2 for the other reaction medium. The inlet 6.1 and the outlet 6.2 (also referred to as ports) are provided at the edge as recesses in one of the two disc parts 2.2, in particular in the area of the frame R of the larger disc part 2.2. The inlets 6.1 and the outlets 6.2 may, for example, be slotted, polygonal, round or of some other suitable shape. In this case, the inlets and the associated outlets are diagonally opposite one another, in a manner which is not illustrated in any more detail. The beads of the channel structures 4.1 and 4.2 run essentially parallel to one another in the longitudinal and lateral direction of the disc parts 2.1 and 2.2, and connect the inlets to the associated outlets.

Transfer elements 8.1 and 8.2 in the form of bridging elements are provided between the respective channel structures 4.1 and 4.2 in order to transfer the reaction media from the respective inlet 6.1 and outlet 6.2 into and out of the relevant channel structure 4.1 and 4.2. The transfer of the reaction media from or to the ports 6.1 and 6.2 respectively into and out of the respective active cell surfaces, that is to say into or out of the flow fields F1 and F2, takes place by means of the transfer elements 8.1 and 8.2 which, for example, may be integrated in an insert seal, may be directly inserted, or may be directly connected to one of the two half-shells. In a further particularly preferred embodiment, the transfer elements 8.1 and 8.2 are fitted directly to the respectively bridged disc part 2.1 or 2.2, to be precise in the area of the larger disc part 2.2 as a flap inlay, and in the area of the smaller disc part 2.1 as an extension in the port direction.

Furthermore, the bipolar plate 1 is completely sealed on the outside by two sealing elements 10.1 and 10.2, for example an elastomer seal, so that there is no need for any sealed joint bead between the two disc parts 2.1 and 2.2. Furthermore, the sealing elements 10.1 and 10.2 separate the reaction media from one another. If one reaction medium enters the cavities created by the joining process between the first and second half-shells, this is irrelevant for operation and operational reliability of the fuel cell. In this case, it is necessary to prevent the two reaction media from entering at the same time. In one particularly preferred embodiment, the sealing elements 10.1 and 10.2 which are required for effective sealing of the fuel cell and of the bipolar plate 1 from the outside are sprayed in a manner which will not be described in any more detail onto adjacent membrane electrode assemblies. The process of spraying the sealing elements 10.1 and 10.2 onto the membrane electrode assembly reduces the number of leak-testing steps required for the fuel cell stack structure from three (1×bipolar plate, 1×membrane electrode assembly, 1×fuel cell stack) to two (1×membrane electrode assembly, 1×fuel cell stack), thus leading to a corresponding cost saving.

In a further embodiment, the disc part 2.1 may be provided in a manner which is not described in any more detail with a number of apertures such that the cavities between the two disc parts 2.1 and 2.2 are filled with reaction medium. In the event of a disturbance in the supply of reaction medium, the medium which is stored there can act as a buffer, and can maintain the fuel cell reaction by diffusion processes of the reactant from the cavity into the reaction area, for a limited time.

FIG. 2 shows a perspective illustration of one exemplary embodiment of the larger of the two disc parts 2.2 as shown in FIG. 1, with the inside at the top and the outside at the bottom. Half of the disc part 2.2 is illustrated, and is in the form of a metal sheet with a channel structure 4.2 formed in it. On the outside, the channel structure 4.2 forms the flow field F2 for a reaction medium. The channels run parallel in the longitudinal and lateral directions of the bipolar plate 1. The channel structure 4.2 is connected to the outlet 10.2 in order to carry the reaction medium away.

The channel structure is connected, in a diagonally opposite form that is not illustrated in any more detail, to an inlet for supplying the reaction medium. The external dimensions of the disc part 2.2 in this case correspond to the external dimensions of the frame R which surrounds the channel structure 4.2 with the flow field F2, and the recesses for the inlet 10.1 and the outlet 10.2.

FIG. 3 shows, schematically and in the form of a perspective illustration, one exemplary embodiment of the smaller of the two disc parts 2.1 as shown in FIG. 1. The dimensions of the disc part 2.1 in this case correspond to the dimensions of the flow field F1.

FIG. 4 shows, schematically, the two disc parts 2.1 and 2.2 as shown in FIGS. 2 and 3, as well as the bipolar plate 1 as shown in FIG. 1, in the joined state. In this case, the two disc parts 2.1 and 2.2 are joined to one another at least in places in the mutually facing rim area, for example by welding, soldering or adhesive bonding.

FIG. 5 shows, schematically, a transfer element 8.1 in the area of the inlet 6.2 for the channel structure 4.1 of the disc part 2.1 as shown in FIG. 1. The transfer element 8.1 may be inserted separately, as a metal sheet. The transfer element 8.1 may also be inserted separately as a metal sheet, or sprayed as a plastic part onto the disc part 2.2 in the area of the frame 6.

FIG. 6 shows, schematically, the sealing element 10.1 as shown in FIG. 1, which surrounds the small disc part 2.1 as well as the inlet 6.1 and the outlet 6.2, and rests on the large disc part 2.2 in the area of the frame R. The sealing element 10.1 is formed from an elastically deformable material and, for example, is in the form of an elastomer seal.

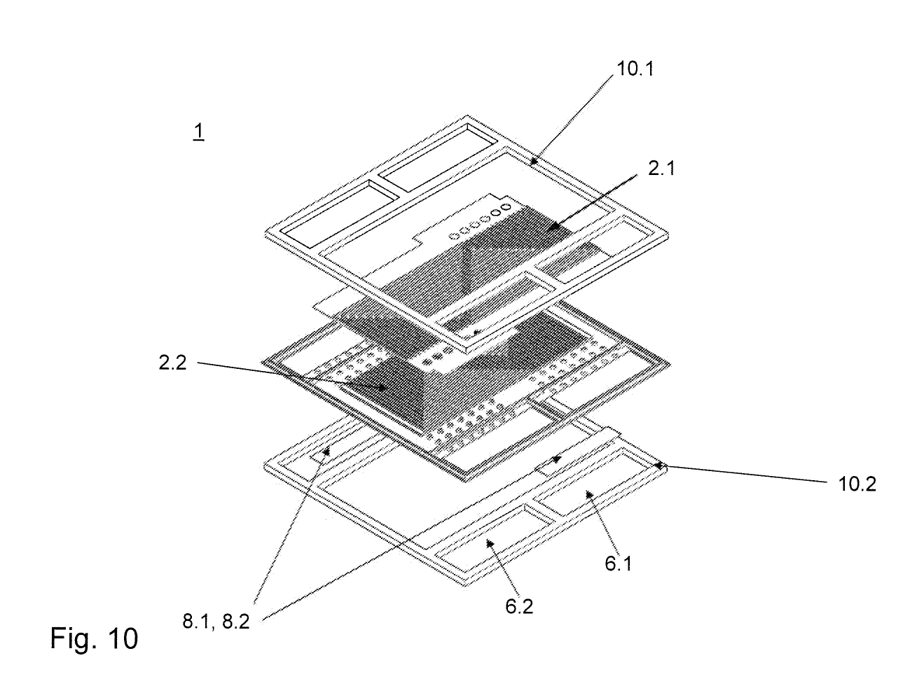

FIGS. 7 to 9 show, schematically, various embodiments of a sealing element 10.1 and 10.2. FIG. 7 shows the sealing element 10.1 or 10.2 with an integrated transfer element 8.1 or 8.2, respectively. FIG. 8 shows a flat sealing element 10.1 and 10.2 with recesses for the inlets and the outlets. Furthermore, the sealing element 10.1 or 10.2 may, if required, have sealing areas of different height (see FIG. 9), thus resulting in the bipolar plate 1 being sealed from the outside and forming a seal between the reaction media.

In further preferred embodiments, the respective bipolar plate 1 is sealed from the outside and provides a seal between the reaction media by means of an elastomer seal which is sprayed onto the bipolar plate 1. In one alternative embodiment, the respective bipolar plate 1 may be sealed from the outside and may form a seal between the reaction media by means of an elastomer seal which is sprayed onto the membrane electrode assembly and may have sealing areas of different height.

FIGS. 10 to 14 show a further exemplary embodiment of the bipolar plate 1 in the form of an exploded illustration and a perspective illustration. FIG. 10 shows all the components—small disc part 2.1, large disc part 2.2 sealing elements 10.1 and 10.2 providing the seal from the outside, as well as transfer elements 8.1 and 8.2, such as flap inlays, for bridging cutouts in the area of the inlets 6.1 and outlets 6.2 of the bipolar plate 1, in the form of an exploded illustration showing their overall size.

FIG. 11 shows the larger disc part 2.2 with the inlets 6.1 and the outlets 6.2, as well as the smaller disc part 2.1 which is to be joined and to be inserted into one of the sealing elements 10.1, and their respective channel structures 4.2 and 4.1, the latter of which can be seen while the former cannot, with the associated flow fields F2 and F1, respectively. Supporting elements 16, for example supporting studs, are provided in the port area of the larger disc part 2.2 in order to support the smaller disc part 2.1 (also referred to as an inlay sheet). The smaller disc part 2.1 is therefore supported over a large area on the channel structure 4.2 located under it, and in the port area on the supporting elements 16.

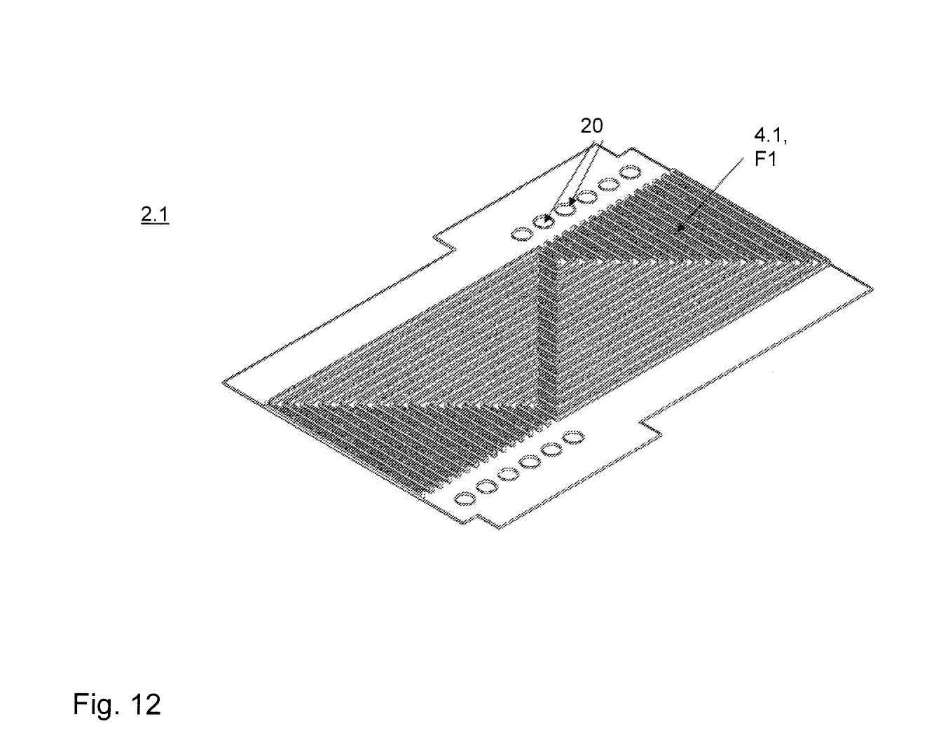

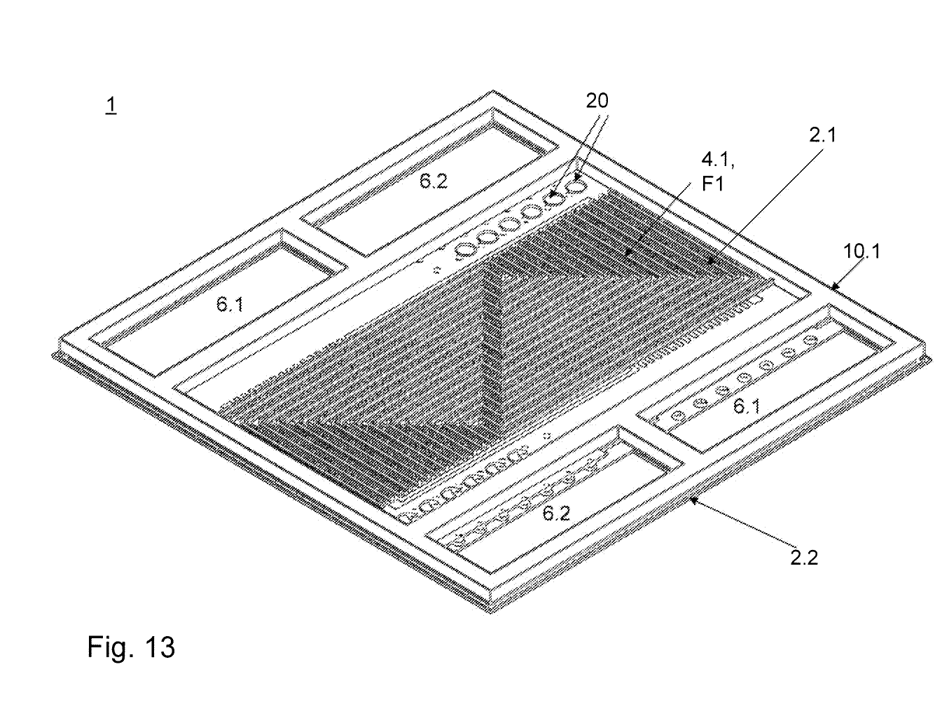

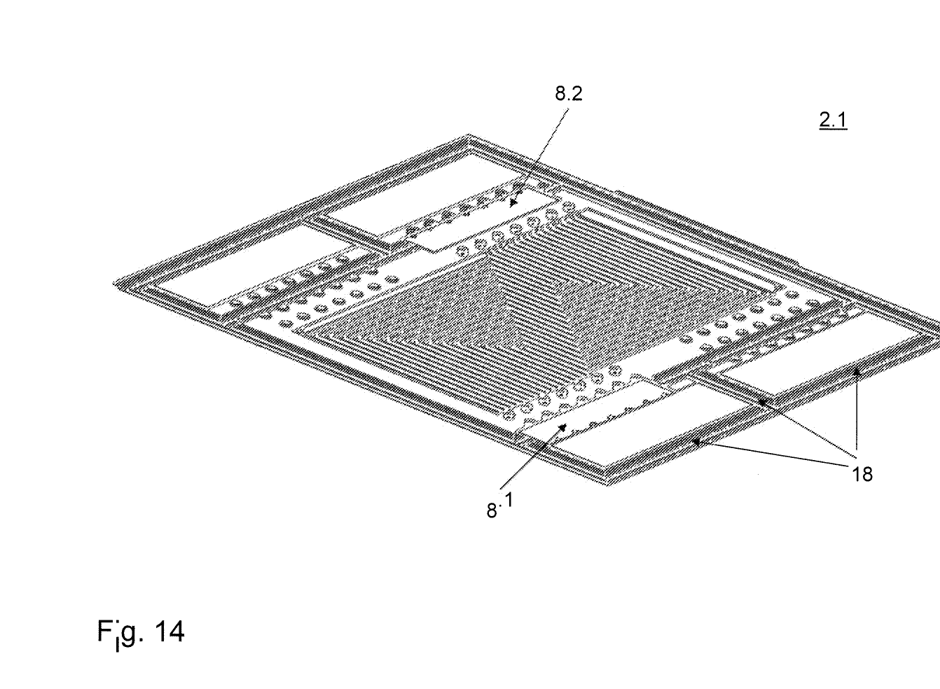

Seen from the port area, that is to say from the inlets 6.1 and the outlets 6.2, the channel structure 4.1 for the flow field F1 of the smaller disc part 2.1 can start immediately after the sealing element 10.1, which is not shown in any more detail in this FIG. 11. For this purpose, the smaller disc part 2.1 is provided with openings 20 in the inlet and outlet area of the flow field F1, and is therefore permeable, in order to allow the reaction medium to be transferred from the inlet 6.1 on the upper face of the disc part 2.1 and from there in turn to the lower face of the disc part 2.1, and to flow on to the outlet 6.2. These openings 20 may be formed by simple holes, polygonal stamped areas or slots etc., even in front or actually within the channel structure 4.1 of the disc part 2.1. FIG. 12 shows an exemplary embodiment of a smaller disc part 2.1 with the openings 20 for the reaction medium or the reaction products to be transferred to the other side of the sheet. FIG. 13 shows the two joined disc parts 2.1 and 2.2 as shown in FIG. 11, with the sealing element 10.1 arranged on top.

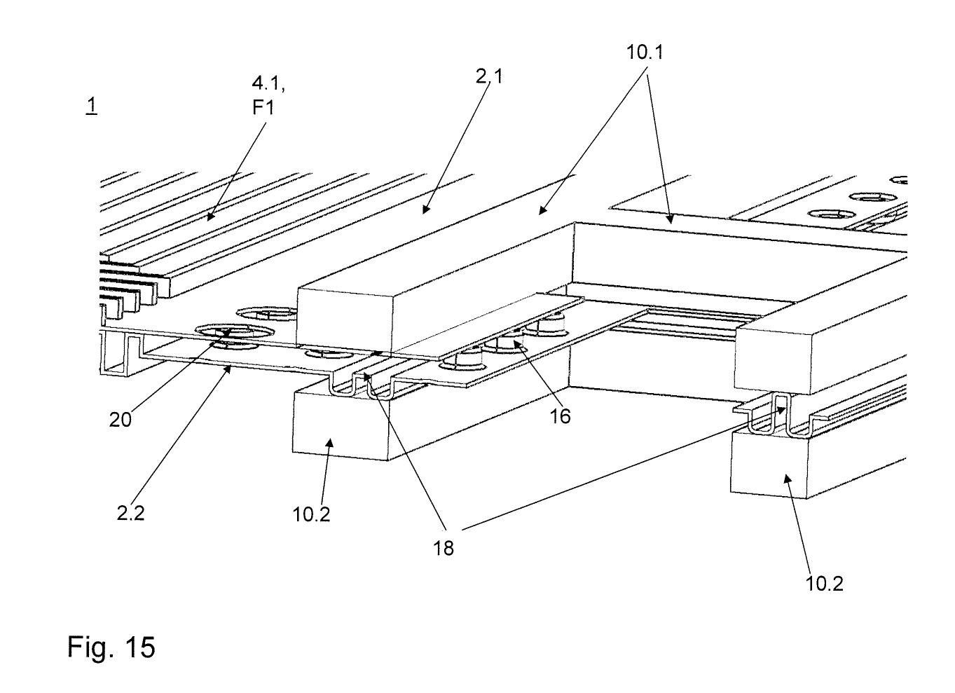

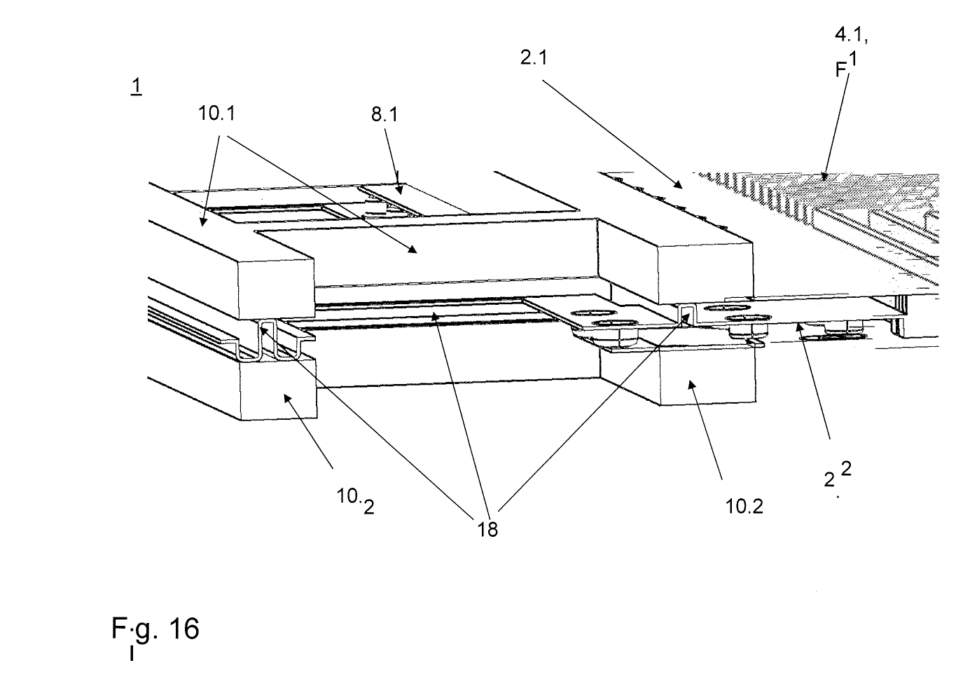

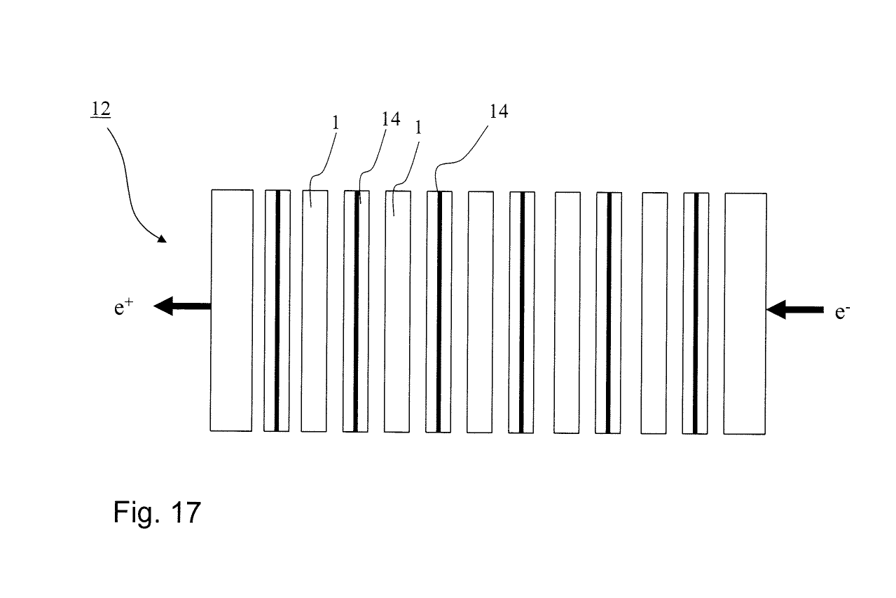

In order to allow the disc part 2.2 with the larger external dimensions to be sealed sufficiently well both on its upper face (see FIG. 11, upper face=positive form after forming) and on its lower face (see FIG. 14, lower face=negative form after forming) by means of the respective sealing element 10.1 or 10.2, the disc part 2.2 is provided with a web 18 which acts as a base for the respective sealing elements 10.1 and 10.2 and whose circumferential upper edges or fins lie on one plane. FIGS. 15 and 16 show one exemplary embodiment of a bipolar plate 1 from the side, in the form of a perspective illustration, illustrating the web 18 (also referred to as a sealing web) that is incorporated in the area of the frame R of the larger disc part 2.2. This web 18 must have at least one raised contour for each sheet-metal side of the disc part 2.2 (similar to a sine wave in cross section). In order to ensure sealing on both sides even in the case of webs which abut against one another in a T-shape, the web 18 is formed centrally in one direction, and in the correspondingly different direction on both sides of the web 18 thus resulting in a cross section similar to one and a half cycles of a sine wave (=double-wave contour). This allows sealing elements 10.1 and 10.2 with a constant thickness to be used on both sides for the bipolar plate 1. The respective sealing element 10.1 or 10.2 with a constant thickness can be produced at a lower cost in a seal with a partially varying thickness (for example by means of cutouts). Since a continuous web 18 is provided on each side of the disc part 2.2, whose cutouts are bridged at the ports by transfer elements 8.1 and 8.2 such as flap inlays, this makes it possible to use a flexible seal, which always has the same thickness.

In order to position the sealing element 10.1, 10.2 before fitting, it is particularly advantageous to provide one sealing element 10.2 with a T-shaped cross section, and the other sealing element 10.1 with a U-shaped cross section, on the side facing the disc part 2.2. (For the sake of simplicity, the sealing elements 10.1, 10.2 illustrated in FIGS. 1 to 16 are shown with a rectangular cross section.) The center rib (“the vertical trunk of the T” of the sealing element 10.2) can therefore engage in the central bead (see FIGS. 15 and 16) of the sealing web 18 when it makes contact or is pressed against it, forming the central web on the other side of the metal sheet. The sealing element 10.2 is thus centered above the sealing web 18 and is secured against sliding during fitting. The other seal 10.1, which is fitted on the disc part 2.1 or the disc part 2.2, is “placed” with its U-profile over the central rib (see FIGS. 15 and 16) of the sealing web 18, and is therefore likewise centered. Furthermore, the profiling of the sealing elements 10.1, 10.2 lengthens the sealing gap, thus resulting in a better sealing effect for the same contact pressure.

If the inlay metal sheet or smaller disc part 2.2 is “raised”, for example by means of the supporting elements 16, that is to say between the zero level of the base sheet or inlay sheet, this results in a certain distance, and the sealing element 10.1 can be placed directly over the smaller disc part 2.1 to be inserted, because the sealing web 18 and the upper face of the disc part 2.1 lie on one plane. A transfer element, for example a flap inlay, which would otherwise be required for this port can therefore in each case be saved in the inlet ports 6.1 for the reaction medium which is intended to flow over the disc part 2.1. The vertical distance between the large disc part 2.2 (=surface of the base sheet) and the lower face of the small disc part 2.1 (=inlay sheet) is at the same time the height of the flow cross section in the constriction between the inlet 6.1 and the flow field F1.

FIG. 17 shows, schematically, a bipolar fuel cell stack 12 which comprises a plurality of individual fuel cells. In this case, the fuel cell stack 12 is composed alternately of bipolar plates 1 stacked one on top of the other and membrane electrode assemblies 14.

1. A bipolar plate for a fuel cell stack, comprising two disc parts which are electrically conductively connected to one another and of which a first disc part only partially covers a second disc part in the stacking direction of the fuel cell stack.

2. The bipolar plate as claimed in claim 1, with the second disc part being provided with one or more inlets and/or outlets, which are in the form of apertures, for a first reaction medium, and with an area of the second disc part which is not covered by the first disc part comprising a part of the circumferential rim, in particular the entire circumferential rim of at least one or all of the apertures.

3. The bipolar plate as claimed in claim 1, with the disc parts each having at least one associated flow field which is formed at least in places by at least one channel structure.

4. The bipolar plate as claimed in claim 3, with the flow field of one disc part being formed on the outside, facing away from the other disc part.

5. The bipolar plate as claimed in claim 2, with the external dimensions of one of the disc parts corresponding at least to the external dimensions of the associated flow field.

6. The bipolar plate as claimed in claim 5, with the external dimensions of the other disc part corresponding at least to the external dimensions of the associated flow field and of a frame which surrounds this flow field.

7. The bipolar plate as claimed in claim 6, with the larger disc part being provided in the area of the frame with inlets for supplying reaction media, in particular hydrogen and air, and corresponding outlets for carrying away the reaction media, in particular hydrogen and air.

8. The bipolar plate as claimed in claim 7, with transfer elements being provided in the area of the inlets and of the outlets in order to pass the reaction media into and out of the associated flow field.

9. The bipolar plate as claimed in claim 8, with the transfer elements being arranged in the form of flap inlays on the associated disc part.

10. The bipolar plate as claimed in claim 3, with the flow fields each being surrounded by a sealing element.

11. The bipolar plate as claimed in claim 10, with the sealing elements sealing the flow fields from one another and from the outside.

12. The bipolar plate as claimed in claim 10, with the sealing element being arranged on both sides in the area of the frame of the larger disc part, and with the smaller disc part being surrounded by one of the sealing elements.

13. The bipolar plate as claimed in claim 10, with the sealing element being in the form of a further disc part composed of an elastically deformable material, in particular in the form of an elastomer seal.

14. The bipolar plate as claimed in claim 10, with the sealing element being arranged on, in particular sprayed on, one of the disc parts, in particular on the larger disc part.

15. The bipolar plate as claimed in claim 10, with the sealing element being arranged on, in particular sprayed on, a membrane electrode assembly which is adjacent to the disc parts on the outside.

16. The bipolar plate as claimed in claim 10, with the sealing element being of different height.

17. The bipolar plate as claimed in claim 10, with the respective sealing element being arranged on a sealing web of the larger disc part.

18. The bipolar plate as claimed in claim 10, with the frame being provided with a recess for holding the sealing element.

19. The bipolar plate as claimed in claim 1, with one of the disc parts being provided with openings, in particular tapping holes, slots, rectangles, squares, and with the internal cavity between the two disc parts being filled with a relevant reaction medium.

20. The bipolar plate as claimed in claim 1, with the disc parts being formed metal parts, with the forming of the disc parts on the respective outside forming an associated outer flow field for reaction media, and with the respective negative of the outer flow fields forming the inner cavities.

21. A bipolar fuel cell stack having a bipolar plate as claimed in claim 1.

22. The bipolar fuel cell stack, in particular as claimed in claim 21, having at least one bipolar plate, a sealing element and at least one electrolyte unit, in particular a membrane electrode assembly, with the bipolar plate having two disc parts which are electrically conductively connected to one another, a first disc part of which at least partially covers a second disc part in the stacking direction of the fuel cell stack and is arranged in an intermediate area between the electrolyte unit and the second disc part, with the second disc part being provided with one or more inlets and/or outlets, which are in the form of apertures, for a first reaction medium, and with the sealing element sealing at least one or all of the apertures from the intermediate area with the first disc part.

23. The bipolar fuel cell stack as claimed in claim 21, with the sealing element touching part of the circumferential rim, in particular the entire circumferential rim of at least one or all of the apertures.

24. The bipolar fuel cell stack as claimed in claim 21, with a sealing element being arranged on both sides of the bipolar plate, between it and an adjacent membrane electrode assembly.

25. The bipolar fuel cell stack as claimed in claim 21, with the sealing element being sprayed onto the membrane electrode assembly as a further disc part.

26. The bipolar fuel cell stack as claimed in claim 21, with the sealing element being sprayed onto the bipolar plate, as a further disc part.

27. The bipolar fuel cell stack as claimed in claim 21, with the flow fields being surrounded by a respective sealing element.

28. The bipolar fuel cell stack as claimed in claim 21, with the sealing elements sealing the flow fields from one another and from the outside.

29. The bipolar fuel cell stack as claimed in claim 21, with the sealing element being arranged on both sides in the area of the frame of the larger disc part, and with the smaller disc part being surrounded by one of the sealing elements.

30. The bipolar fuel cell stack as claimed in claim 21, with the sealing element being in the form of a further disc part composed of an elastically deformable material, in particular an elastomer seal.

31. The bipolar fuel cell stack as claimed in claim 21, with the sealing element being arranged on, in particular sprayed on, one of the disc parts, in particular on the larger disc part.

32. The bipolar fuel cell stack as claimed in claim 21, with the sealing element being arranged on, in particular sprayed on, a membrane electrode assembly which is adjacent to the disc parts on the outside.

33. The bipolar fuel cell stack as claimed in claim 21, with the sealing element having a different height.

34. The bipolar fuel cell stack as claimed in claim 21, with the respective sealing element being arranged on a sealing web of the larger disc part.

35. The bipolar fuel cell stack as claimed in claim 21, with the frame being provided with a recess for holding the sealing element.

36. The bipolar fuel cell stack as claimed in claim 21, one of the disc parts being provided with openings, in particular tapping holes, slots, rectangles, squares, and with the internal cavity between the two disc parts being filled with a relevant reaction medium.

37. The bipolar fuel cell stack as claimed in claim 21, with the disc parts being formed metal parts, with the forming of the disc parts on the respective outside forming an associated outer flow field for reaction media, and with the respective negative of the outer flow fields forming the inner cavities.
